(19) United States
(12) Patent Application Publication
(10) Pub. No.: US 2012/0003386 A1
(43) Pub. Date: Jan. 5, 2012

(54) METHOD FOR PRODUCING AMORPHOUS METAL ORGANIC MACROMOLECULES, MATERIAL OBTAINED BY SAID METHOD, AND USE THEREOF

(75) Inventors: Matthias Bockmeyer, Mainz (DE); Uwe Guntow, Wuerzburg (DE); Bernd Pietschmann, Dettelbach (DE)

(73) Assignee: FRAUNHOFER-GESELLSCHAFT FÖRDERUNG DER ANGEWANDTEN FORSCHUNG E.V., Muenchen (DE)

(21) Appl. No.: 12/672,380

(22) PCT Filed: Aug. 1, 2008
(86) PCT No.: PCT/EP2008/060184

§ 371 Date: Sep. 15, 2011

(30) Foreign Application Priority Data
Aug. 6, 2007 (DE) 10 2007 036 998.2

(51) Int. Cl. C09D 1/00; B05D 3/02

(52) U.S. Cl. 427/226; 106/287.24; 427/372.2

(57) ABSTRACT

The present invention relates to a method for producing a material suitable for producing ceramic oxide coatings, comprising the following steps: (a) preparing at least one first compound of a metal cation, selected from the cations of manganese, cerium, gadolinium, and/or yttrium, having at least one organic anion or an anion comprising an organic part, (b) dissolving or suspending the compound(s) prepared according to (a) in a protic, hydrolytically active solvent, such that the compound(s) is (are) present in a completely dissolved or colloidally dispersed form, (c) heating the suspension or solution thus formed in a closed vessel to at least 80° C., and (d) expanding and cooling the suspension or solution thus formed. Using said method, amorphous macromolecules are obtained, comprising molecular or polycyclic complexes having a primary particle size of <1 nm and an agglomerate size of 5 to 120 nm, preferably 10 to 80 nm. Applied to a substrate as a solution or suspension, said particles yield a coating material by means of which dense oxide coatings can be obtained even at relatively low temperatures.

The present invention relates to metal-organic macromolecules of compounds of the elements manganese, cerium, gadolinium and yttrium in amorphous form, preferably in the form of coating materials which are suitable for producing, if appropriate, very dense ceramic layers which can be used as, for example, diffusion barrier layers or epitactic (barrier) layers.

Hydrothermal processes by means of which, for example, zirconium dioxide can be obtained in a form which is suitable for further processing in the ceramics industry have become a focus of interest since about 15 years ago. Thus, U.S. Pat. No. 5,037,579 by Matchett describes the production of a colloidal sol by hydrothermal treatment of a solution of zirconium acetate in highly concentrated acetic acid. The hydrothermal treatment comprised treating said solution at about 140°-170° C. for a number of hours in an autoclave. The product, a milky-white suspension, was depressurized by quenching and subsequently subjected to a filtration by dialysis, by means of which components dissolved in the permeate, obviously organic components, were removed. The purified sol was subsequently concentrated by ultrafiltration, with a solids concentration of ZrO₂ of up to 11.75% by weight being able to be achieved.

A zirconium dioxide sol in which the ZrO₂ is present in the form of many individual crystalline particles was, according to U.S. Pat. No. 6,376,590 B2, obtained by hydrolyzing a zirconium salt of a polyether acid in aqueous solution having a relatively low concentration under superatmospheric pressure and elevated temperature (above 175° C.) US 2006/0148950 A1 describes the production of colloidal, crystalline zirconium dioxide particles by means of an at least double hydrothermal treatment. Here, the supernatant liquid from the first hydrothermal treatment is discarded. The zirconium dioxide can contain up to 8% by weight of yttrium.

Recently, too, the development of processes for producing crystalline metal oxide particle suspensions has been pursued further, see, for example, the DE applications 10 2006 032759.4 and 10 2006 0322755.1, which had not yet been published at the priority date of the present application, which are directed at stable suspensions of crystalline ZrO₂ and TiO₂ particles.

DE 10 2004 048230 A1 discloses a process for producing a suspension of crystalline and/or densified, surface-modified, nanosize particles in a dispersion medium. Here, the expression “densified” is not defined; instead, it is stated that crystallization and densification are mutually dependent and that densification is associated with crystallization. Preference is given to obtaining crystalline particles. The production of amorphous particles is not described. The process comprises a hydrothermal treatment of particles which have not been surface-modified and the subsequent surface modification thereof. The process is obviously intended to be used for a virtually unlimited number of materials. In general, purely inorganic substances are proposed as starting materials, but organic substances, for example alkoxides or acetates, are said to be able to be used, too, without this being demonstrated by examples. The description states that process by-products such as alcohols formed by hydrolysis of alkoxides can, if appropriate, be separated off in an optional purification step. The examples demonstrate the production of nanosize, optionally doped, surface-modified cubic ZrO₂.

Crystalline coating materials produced using such suspensions do have a series of advantages but they are insufficiently sinter-active and therefore do not give sufficiently dense layers at the low sintering temperatures which are generally to be preferred. Wetting of the substrate leaves something to be desired and there is generally a tendency for cracks to be formed during sintering. In addition, the homogeneity of the layers produced therefrom frequently leaves something to be desired.

It is an object of the present invention to provide chemical substances and macromolecules formed therefrom which are suitable for use in coating materials for oxidic coatings and do not have the abovementioned disadvantages. The coating materials according to the invention should be able to be converted into preferably dense oxide layers at relatively low temperatures.

The object is achieved by provision of amorphous macromolecules which have metal cations selected from among those of manganese, cerium, gadolinium and yttrium and also an organic component. The macromolecules mentioned can be present in the form of an in particular liquid to paste-like coating material or else as virtually or completely solid material.

The inventors have surprisingly found that the metal cations mentioned allow the amorphous coating material of the invention to be produced, while it is not possible to produce such coating materials from any metal salt in a manner analogous to the invention. For example, the analogous treatment of titanium or zirconium salts gives a crystalline coating material. However, crystalline coating materials can be converted into dense layers only at significantly higher temperatures than amorphous coating materials. This is a great disadvantage in a number of applications since not all substrates withstand such high temperatures. In contrast, sintering of the coating materials of the invention leads to oxide layers having a high density and therefore also to a very low pore volume, even at low temperatures, unless specific measures are taken to make the layers porous.

Apart from the metal cations of manganese, cerium, gadolinium and/or yttrium, further cations which together with one or more of the four cations mentioned form mixed oxides in the identical or at most only slightly distorted oxide structure of the oxides of manganese, cerium, gadolinium or yttrium or the mixed oxides of these metals can be present in the macromolecules of the invention (these further cations are referred to as doping ions). It can be seen that the proportion of such doping ions has an upper limit imposed exclusively by the circumstances of crystal lattice formation. Thus, such doping ions can be present, for example, in a mole fraction of up to 70%, preferably up to 50%, more preferably up to 20-40% and most preferably in a mole fraction of from <0.1% to about 1-2%, based on the sum of the cations present.

The doping ions are preferably selected from among the cations of the elements in main groups II, III, IV, V and VI (in particular Mg, Ca, Sr, Ba, Al, Ga, In, Si, Ge, Sn, Pb, As, Sb, Te), the copper group (namely Cu, Ag, Au), the zinc group (namely Zn, Cd), the scandium group (namely Sc, Y, La, Ce, Pr, Nd, Pm, Sm, Eu, Gd, Er and, less preferably, further lanthanides), the vanadium group (namely V, Nb, Ta), the chromium group (namely Cr, Mo, W), the manganese group (namely Mn, Tc, Re), the iron group (namely Fe, Co, Ni) and the group of platinum metals (namely Ru, Rh, Pd, Os, Ir, Pt). If appropriate, cations of the elements titanium and zirconium can also be added to produce the macromolecules as long as it is ensured, for the abovementioned reasons, that the basic structure of the oxide to be produced is not altered and, in particular, the structure of titanium dioxides or zirconium dioxides or mixed oxides, e.g. rutile, anatase, baddeleyite or lead zirconate titanates is not formed. The addition of zirconium cations is somewhat less advantageous because the products tend to form proportions of crystalline material. The doping ions are particularly preferably cations of Mg, Ca, Sr, Ba, Sc, Y, La, Hf, V, Nb, Ta, Cr, Mo, W, Re, Fe, Ru, Co, Rh, Ir, Ni, Pd, Pt, Cu, Ag, Au, Zn, B, Al, Ga, In, Si, Ge, Sn, Pb, As, Sb, Te, Sm, Eu, Er, Pm, Pr and mixtures thereof.

The organic component is introduced into the amorphous macromolecules by the use of organic anions or anions containing organic components. These anions are preferably complexing ligands and/or chelating agents. It is possible for one or more such anions to be present, either exclusively or in admixture with further anions.

Suitable organic anions or anions containing organic components are, in particular, the anions of monocarboxylic, dicarboxylic or higher carboxylic acids which may contain further substituents such as one or more hydroxy groups, (poly)ether groups, keto groups, amino groups or thiol groups and/or whose carbon chain can be interrupted by oxygen and/or sulfur atoms and/or amino groups, preferably having 1-30 carbon atoms, and can be interrupted by substituted or unsubstituted monoalcohols, dialcohols or higher alcohols which may contain further substituents such as one or more hydroxy groups, (poly)ether groups, keto groups, amino groups or thiol groups and/or whose carbon chain can be interrupted by oxygen and/or sulfur atoms and/or amino groups, preferably having from 1 to 20 carbon atoms. The anions can be used alone or as a mixture of various anions of this type. Preference is given to anions which are made up exclusively of carbon, oxygen and hydrogen atoms. Examples are anions of monocarboxylic acids having preferably from 1 to 10 carbon atoms, in particular formate, acetate and propionate, of (poly)ethercarboxylic acids such as methoxyethoxyacetic acid (MEAH), methoxy acetic acid (MAH) or ethoxy acetic acid (EAH), of carboxylic acid ketones such as acetylacetones, anions of alcohols or alkoxy alcohols, in particular those having from 1 to 20 carbon atoms, e.g. 1-methoxy-2-propanol, and alkoxy radicals such as methoxy, ethoxy, propoxy. Further examples are anions of alkanedicarboxylic acids, of (meth)acrylic acid and (meth)acrylic acid derivatives or of long-chain carboxylic acids, in particular those having from 11 to 26 carbon atoms.

For the purposes of the invention, the expression “amorphous macromolecules” refers to macromolecules which are generally free of proportions of crystalline material. This can be confirmed by means of the corresponding XRD patterns.

The amorphous macromolecules or agglomerated molecules of the invention can, as mentioned above, be obtained by a hydrothermal process. For this purpose, dissolved or colloidally dispersed or molecularly dispersed metal-organic compounds in which the metal cations are present in combination with the abovementioned organic anions or anions containing organic components, in the presence or absence of further anions, in pure or mixed form, are used as starting materials. Appropriate salts or complexes are commercially available or can easily be prepared by a person skilled in the art, for example by direct synthesis or by partial or complete replacement of anions by suitable counterions or ligands/chelating ligands. Examples are the (partial or complete) reaction of chlorides, acetates, acetylacetonates or the like with alkanedioic acids, methacrylic acids, long-chain carboxylic acids or polyethercarboxylic acids such as methoxyethoxyacetic acid, methoxyacetic acid or ethoxyacetic acid. For this purpose, the starting materials are dissolved or suspended in a suitable, polar and frequently protic solvent. Suitable solvents are, in particular, water, alcohols having preferably from 1 to 10 carbon atoms, e.g. dilute organic acids or mixtures thereof, in other, less preferred cases also ether or ketones, without being restricted thereto. Water, alcohols and mixtures of water and alcohol(s) are preferred. The solutions or suspensions are preferably heated for some time, e.g. from 5 minutes to a number of hours. This is preferably carried out under reflux in order to lose a little if any solvent. This firstly forms (mono)molecular or else multinuclear compounds or complexes having a primary particle size of generally less than 1 nm and an agglomerate size in the solvent in the range of mainly from 0.5 to 2 nm.

Even when the starting materials are already present in a suitable form and do not have to be prepared or reacted, preference is given to keeping them in motion in the intended solvent for some time, if appropriate with heating.

Should the solvent used for the above-described step be unsuitable or not very suitable for the subsequent hydrothermal treatment, it is, if possible, entirely or partly replaced by a solvent suitable for this treatment, for example by evaporating the solution or suspension until a paste-like or viscous mass has been formed. The mass is then taken up in a solvent suitable for the hydrothermal treatment. When such a solvent is present at the beginning, the solution or suspension may be diluted or evaporated in a suitable manner.

A protic, hydrolytically active solvent, e.g. an alcohol, water or an alcohol/water mixture, is suitable for the hydrothermal treatment. Water is preferred.

For the purposes of the present invention, the expression “hydrothermal treatment” refers to a treatment at elevated temperature and under an increased pressure compared to ambient conditions. The temperature is preferably in the range from about 100° C. to 220° C., more preferably from about 160 to 220° C. The treatment is carried out in a closed vessel (an autoclave). As a result of the heating, the pressure builds up without the possibility of depressurization. The duration of the treatment is from a few minutes to preferably a number of hours or even days.

A single hydrothermal treatment is generally sufficient for the process of the invention. Multiple treatments with replacement of the supernatant liquid by fresh solvent can at least in some cases, as the inventors have found, result in the product no longer being completely amorphous.

It has surprisingly been found that the preferably only single hydrothermal treatment of metal compounds having the abovementioned cations, if appropriate in admixture with the doping ions mentioned, which in each case contain organic anions or anions having organic components makes it possible to obtain amorphous molecular agglomerates (amorphous metal-organic macromolecules) which owing to their amorphous character have superior properties. These molecular agglomerates have an agglomerate size in the solvent of generally from about 10 to about 80 nm. The primary particles (molecules) still have a particle size of generally <1 nm. This means that the primary particle size remains constant compared to the starting material; however, the agglomeration of the molecules formed is significantly stronger than that of the starting materials.

The hydrothermal treatment gives, according to the invention, macromolecules which are suitable for use in coating materials. The molecular agglomerates can be used, in particular, in the form of coating materials having long-term stability, e.g. as coating solutions, coating gels or coating suspensions of finely divided particles having diameters in the nanometer range. These materials can easily be applied to a substrate. The coating obtained can then be dried and heated or sintered so that the organic constituents are, if appropriate, partly evaporated and otherwise removed by conversion into CO₂ or other oxidation, forming a, preferably ceramic, oxide layer.

The properties of the coating materials are significantly improved as a result of the hydrothermal treatment. Thus, a significantly improved wetting of the substrate on application of the coating material to a substrate is observed, the tendency for cracks to be formed on drying and during sintering is significantly decreased and the homogeneity of the layer increases. Since the particles of the coating material are, unlike what is known from the prior art, completely amorphous at the time of application of the coating material to the substrate, densification takes place during heating of the layers even at relatively low temperatures, not only in comparison with oxides produced by a purely inorganic route, e.g. via the “mixed oxide process”, i.e. oxides produced by a purely inorganic route and only in the solid state using high sintering temperatures (generally above about 1200° C.) but also compared to hydrothermally treated alkoxides of titanium or zirconium. In addition, the oxide layers formed on sintering are denser and accordingly have a lower surface area and they have little if any porosity.

Owing to the good wetting, the low tendency for cracks to be formed and the ability to be converted into crystalline material which forms a dense coating even at significantly lower temperatures, the macromolecules of the invention in suitable solvents or suspension media are suitable as starting material for any type of oxidic coating, but especially for layers which can prevent the diffusion of other ions/metal atoms (diffusion barrier layers). Examples of the use of such barrier layers are diffusion barrier layers in, for example, catalytic materials for fuel cells or other purposes or barrier layers required for superconductors. Cerium oxides are frequently utilized for such purposes. A barrier or other layers composed of the materials of the invention can be epitactic layers which reproduce the relief structure of the underlying material. If, for example, superconductors are produced using nickel foils, it has to be ensured that no nickel atoms diffuse into the superconductor and poison the latter. In addition, nickel does not tolerate high working temperatures. A diffusion barrier layer, e.g. of cerium oxide, can here be produced by means of the materials of the invention at sufficiently mild temperatures.

In addition, the hydrothermal treatment leads to improved hydrolysis stability both of the coating materials themselves which are still present in bulk form and also (especially) during application and drying of the coatings to form a gel film and subsequent xerogel formation. The xerogel in particular is significantly less hydrolysis-sensitive. As a result, atmospheric moisture is only of minor relevance as process parameter during the coating process and during drying.

Without wishing to be tied thereto, the inventors assume that an essential element of the present invention is that the hydrothermal treatment is carried out using molecules which firstly are amorphous and secondly contain organic constituents. These organic constituents probably interfere in the formation of more highly ordered, crystalline structures during the hydrothermal treatment when the cations which can be used according to the invention are employed. A single hydrothermal treatment (“one-pot reaction”) in particular has the advantage that the reaction is carried out in the presence of the total organic material originally present.

The stable coating material of the invention, comprising the above-described amorphous macromolecules or agglomerated molecules having organic components and a liquid, can contain further constituents. Suitable constituents of this type are, for example, at least partially hydrolytically condensed metal compounds obtained by means of the sol-gel process, e.g. from alkoxides, silanes or other hydrolytically condensable compounds of elements of mainly main groups 3 and 4, e.g. compounds containing boron, aluminum, titanium, silicon, germanium, which are present as separate particles. These compounds are amorphous precursors of further oxides in powder form which should later not be incorporated into the crystal lattice of the oxide to be produced. Instead or in addition, the coating material of the invention can contain oxide powders or other solids which have been obtained, for example, by the “mixed oxide” process. Both types of materials can be utilized, for example, as binders for the production of pastes.

The coating material can contain, instead of the abovementioned condensates or in addition thereto, additives such as alcohols, polyalcohols, carboxylic acids, materials suitable for micelle formation, e.g. triblock copolymers having hydrophilic-hydrophobic-hydrophilic blocks, anionic or cationic surfactants and/or polyethylene glycols. These auxiliaries make it possible to obtain, inter alia and by way of example, targeted pore formation in the end product if required.

Depending on the solvent content or suspension medium content, the coating materials can be fluid to highly paste-like, if appropriate even almost solid.

The coating materials can be used in a variety of ways, e.g. as dip coatings, spray coatings or spin coatings or in various printing processes (inkjet printing, pad printing, screen printing). Further possibilities comprise roller coating, doctor blade coating or coating by means of electrophoresis.

The coating materials of the present invention can frequently be obtained via only one process step, namely when commercially available materials can be employed, because it is not necessary to isolate an intermediate.

A further advantage is the possible variations of the solvents (water, alcohols, carboxylic acids, ketones, etc.). Because there are no restrictions here, as long as the solvent contains water, it is possible, for example, to set the viscosity to a required value within a wide range.

The coatings which can be obtained using the coating material of the invention are particularly suitable, inter alia, as diffusion barrier layers or as epitactic layers.

The invention is illustrated below with the aid of examples.

### EXAMPLE 1

### General Method

The additive, e.g. methoxyethoxyacetic acid (=MEAH), ethanol and Gd acetate and Ce acetate are weighed into a flask and stirred at 80° C. for 30 minutes. The solvent is subsequently taken off on a rotary evaporator (e.g. at 40 mbar, about 140° C.) until a viscous mass is present. This is taken up in water and treated in an autoclave (e.g. for from 1 to 32 h at from 120 to 220° C.)

### EXAMPLE 2

For the synthesis of the hydrothermal CGO coating solution (cerium-gadolinium mixed oxide), the following amounts of substances were used:

| | | | Molar |
|---|---|---|---|
| | Manufacturer (oxide | Mass | amount |
| Chemical | content) | [g] | [mmol] |
| Gd(OAc)₃ × 4 H₂O | ABCR [15280-53-2] | 18.5 | 55.3 |
| | (43.24% by weight) | | |
| Ce(OAc)₃ × 1.5 H₂O | Alfa Aesar [537-00-8] | 73.72 | 232.4 |
| | (50.25% by weight) | | |
| methoxyethoxyacetic acid | | 77.105 | 574.9 |
| ethanol | | 55.783 | 1210.8 |

This solution, which had a theoretical oxide content of 20% by weight, was refluxed for 30 minutes at a heating bath temperature of 100° C. The slightly turbid solution was subsequently evaporated on a rotary evaporator at a heating bath temperature of 80° C. and under reduced pressure (40 mbar) until a viscous mass remained. After cooling, the viscous mass was weighed (154.916 g) and 70.119 g of H₂O were added to the flask. After stirring for three hours, the viscous mass had completely dissolved in the solvent.

For the autoclave treatment, the solution was transferred in its entirety into a Teflon vessel and sealed in a stainless steel bomb. The stainless steel vessel was treated at 160° C. in an oven for 16 hours.

The treated solution was diluted as follows by addition of ethanol and 1-methoxy-2-propanol:

| | | Proportion of |
|---|---|---|
| | | solvent |
| Chemical | Mass [g] | [% by weight] |
| treated solution (20% | 217.02 | 75.00 |
| by weight of oxide) | | |
| ethanol | 61.49 | 21.25 |
| 1-methoxy-2-propanol | 10.85 | 3.75 |

Finally, the coating sol produced (oxide content: 15% by weight) was filtered (1.0 μm round filter).

Owing to the excessively high viscosity for pad printing, the coating solution was diluted to an oxide content of 10% by weight. Dilution was in detail carried out as follows:

| | | Total proportion of |
|---|---|---|
| Chemical | Mass [g] | solvent [% by weight] |
| m (CGO coating | 99.995 | |
| material, 15% by | | |
| weight of oxide) [g] = | | |
| m (H₂O) [g] = | 37.623 | 75.01 |
| m (EtOH) [g] = | 10.628 | 21.24 |
| m (1-methoxy-2- | 1.873 | 3.75 |
| propanol) [g] = | | |

### COMPARATIVE EXAMPLE 2A

Example 2 was repeated but the hydrothermal treatment was omitted.

### EXAMPLE 3

The additive, e.g. methoxyethoxyacetic acid (=MEAH), ethanol and Y triacetate hydrate are weighed into a flask and stirred at 80° C. for 30 minutes. The solvent is subsequently taken off on a rotary evaporator (40 mbar, about 140° C.) until a viscous mass is present. This is taken up in water and treated in an autoclave (e.g. from 1 to 32 h at from 120 to 220° C.)

The resulting solution is diluted to half its concentration with ethanol and can subsequently be used for producing thin layers.

The coating materials according to the invention can be sintered after application of the layer. This is, as mentioned above, carried out at significantly lower temperatures than those required for comparable coating materials whose constituents have not been subjected to hydrothermal treatment. This may be shown by further examples:

### EXAMPLE 4 AND COMPARATIVE EXAMPLE 4A

The coating materials obtained in example 2 and comparative example 2A were each applied to a Borofloat substrate having dimensions of 10*10 cm². The coating and after-treatment parameters were as follows: drawing speed: various (10-60 cm/min); initial drying time: 7 minutes; treatment time in the oven: 10 minutes; aging temperature: 300-600° C.

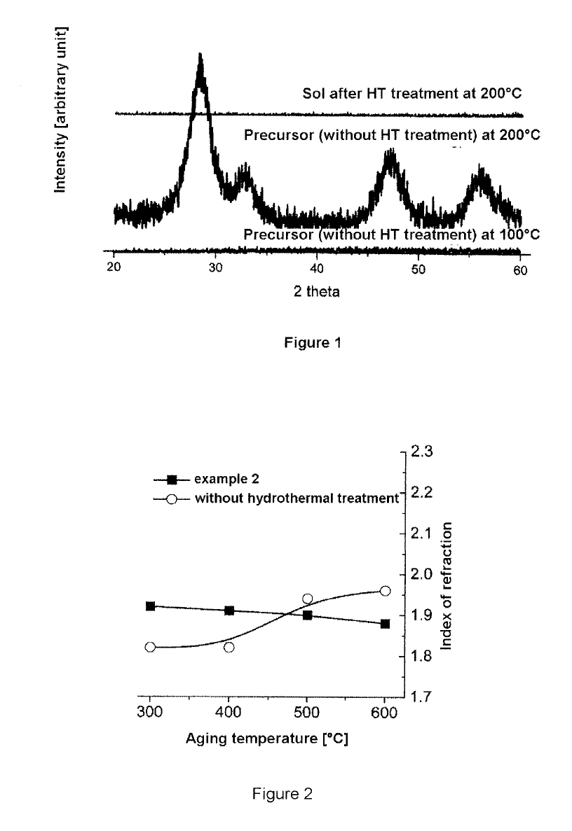

FIG. 1 shows XRD patterns of two coating sols having the composition used in example 2 and comparative example 2A, respectively. The two sols were subjected to sintering at 200° C. It was observed that the coating of comparative example 2A (in the figure designated as “precursor”) which had been produced without hydrothermal treatment (HT) remained amorphous on heating to 100° C.; however, on reaching 200° C., it was crystalline. The hydrothermally treated coating sol of example 2, on the other hand, was found to be still X-ray-amorphous on reaching 200° C. within the same period of time, which is shown by the complete absence of intensity peaks. On further heat treatment at or above 200° C., it is then slowly converted into a crystalline material.

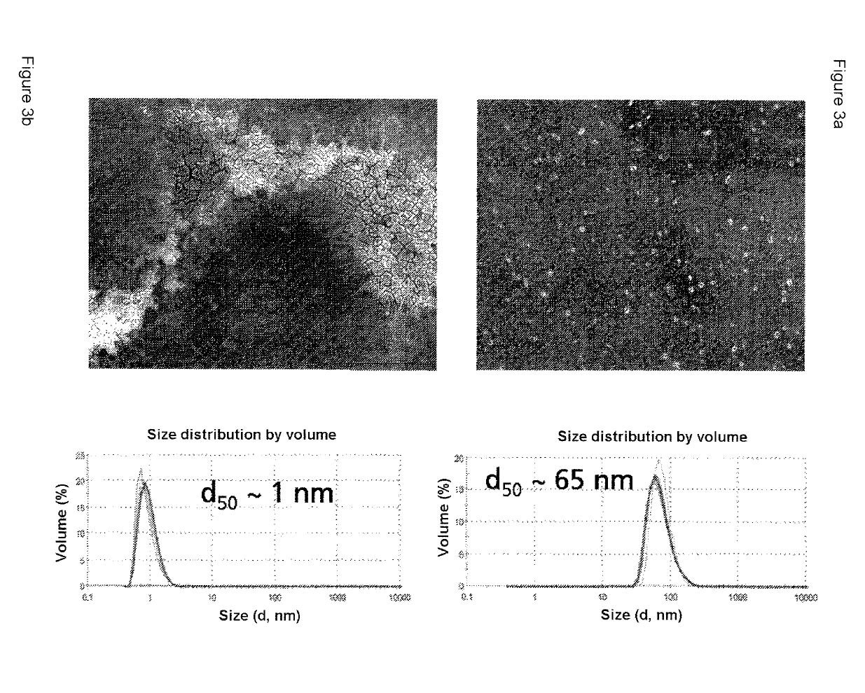

The layers produced using the sol of example 2 display a significantly higher index of refraction than layers produced from the sol of comparative example 2 even at an aging temperature of 300° C., which points to a lower porosity, higher density and continuing burning out of residual organic constituents. FIG. 2 is a graph which shows the dependence of the index of refraction of the materials from example 2 and comparative example 2 (without hydrothermal treatment) on the aging temperature (at a drawing speed of 20 cm/min). The index of refraction is proportional to the density of the layer; the theoretical index of refraction is about 2. It can be seen from FIG. 2 that the material of example 2 barely changes further on increasing the aging temperature from 300° C. to 600° C. This shows that the layer thickness is approximately constant in this temperature range, and the material is therefore dense and without pores even at 300° C. On the other hand, the index of refraction of the material as per comparative example 2A increases significantly with increasing temperatures, which indicates increasing densification.

FIGS. 3a and b show scanning electron micrographs of layers produced from the same coating material. FIG. 3a shows a layer produced using the material as per comparative example 2A while FIG. 3b shows a layer produced from the same material which has been subjected to the hydrothermal treatment according to the invention (see example 2). The graphs showing the average particle size of the starting material before sintering are shown alongside. It can clearly be seen that sintering of a material composed of particles having a diameter d₅₀ in the region of 1 nm leads to a layer having cracks, while the layer produced from agglomerated particles having a diameter d₅₀ in the region of about 65 nm is dense and virtually defect-free.

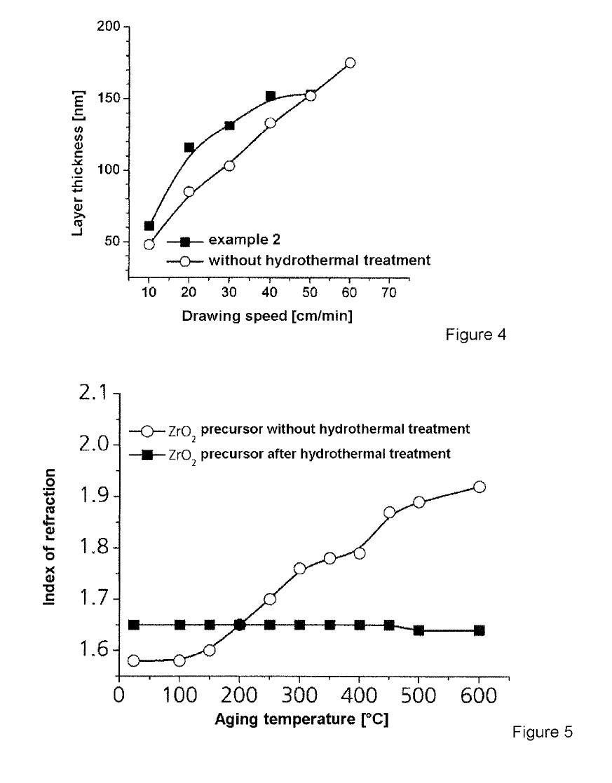

The layer thickness obtained as a function of the drawing speed (aging temperature 500° C.) is shown in FIG. 4 (the black solid squares denote the material of example 2 while the open circles denote the material of comparative example 2A).

### COMPARATIVE EXAMPLE 5

1.0 mol of zirconium tetraacetate is placed in a 2 l round-bottom flask and 3 mol of methoxyethoxyacetic acid are subsequently added dropwise via a dropping funnel while stirring. The material formed is dissolved in water in such an amount that a 10% strength solution is formed.

400 g of this solution are transferred into a 500 ml Teflon vessel which is subsequently sealed in a metal bomb and treated hydrothermally at 160° C. for 24 hours. The resulting suspension contains crystalline particles. It is then admixed with 400 g of ethanol and filtered by means of a pressure filtration apparatus (0.45 μm).

200 nm thick, porous layers are produced using the resulting 5% strength solution by means of dip coating at a drawing speed of 200 cm/min. The wet films are aged at 600° C. for 10 minutes. This results in formation of crystalline zirconium dioxide layers having a porosity (which remains essentially constant over the increase in temperature) of about 40% and a surface area of 70 m²/g.

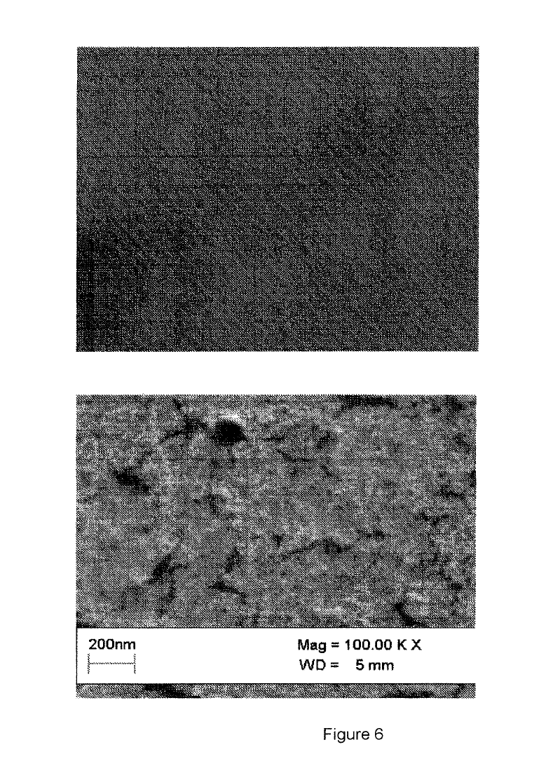

FIG. 5 shows the dependence of the index of refraction on the aging temperature for this material (see black squares) and, as a comparison, for an (amorphous) ZrO₂ precursor which has not been treated hydrothermally (open circles). It can be seen that the crystalline, hydrothermally treated material still remains porous on sintering at up to 600° C., while the amorphous material densifies significantly with increasing temperature. FIG. 6 shows scanning electron micrographs of the two coatings sintered at 500° C. The upper image shows a dense layer formed from the sol which has not been treated hydrothermally. The lower image shows the ZrO₂ layer obtained by sintering of the hydrothermally treated sol. The porosity of the material can clearly be seen.

In summary, the present invention is directed, inter alia, at the following subjects:
A. Process for producing a material which consists of or comprises amorphous metal-organic macromolecules and is suitable for producing ceramic oxide layers, which comprises the following steps:
   (i) provision of at least one first compound of a metal cation selected from among the cations of manganese, cerium, gadolinium and yttrium with at least one organic anion or anion containing an organic component,
   (ii) dissolution or suspension of the compound(s) provided as per (a) in a protic, hydrolytically active solvent in such a way that the compound(s) is/are present in completely dissolved or colloidally dispersed form,
   (iii) heating of the resulting suspension or solution to at least 80° C. in a closed vessel,
   (iv) depressurization and cooling of the resulting suspension or solution.
B. Process according to paragraph A, characterized in that at least one further first compound is provided in step (i), where the cations of the at least two first compounds are identical or different.
C. Process according to paragraph A or B, which comprises, in step (i), provision of at least one second compound of a metal cation selected from the group consisting of cations of the elements Mg, Ca, Sr, Ba, Al, Ga, In, Si, Ge, Sn, Pb, As, Sb, Te, Cu, Ag, Au, Zn, Cd, Sc, La, Pr, Nd, Pm, Sm, Eu, Er, further lanthanides, V, Nb, Ta, Cr, Mo, W, Tc, Re, Fe, Co, Ni, Ru, Rh, Pd, Os, Ir, Pt, Ti and Zr with at least one organic anion or anion containing an organic component, where this/these compound(s) is/are provided in a mole fraction, based on the totality of the compounds present, which on incorporation into an oxide lattice of the first cation/cations does not destroy the lattice structure thereof.
D. Process according to any of the preceding paragraphs, characterized in that the at least one organic anion or anion containing an organic component of the first compound(s) is selected from among complexing and/or chelating ligands for manganese, cerium, gadolinium and yttrium cations.
E. Process according to any of the preceding paragraphs, wherein the at least one organic anion or anion containing an organic component of the first compound(s) and/or the second compound(s) is selected from among unsubstituted or substituted anions of monocarboxylic, dicarboxylic or higher carboxylic acids, of unsubstituted or substituted anions of monoalcohols, dialcohols or higher alcohols and of unsubstituted or substituted anions of esters, ethers and ketones.
F. Process according to paragraph E, wherein the carboxylic acids mentioned and/or the alcohols mentioned each contain one or more hydroxy groups, (poly)ether groups, keto groups, amino groups or thiol groups and/or the carbon chain thereof is interrupted by oxygen and/or sulfur atoms and/or amino groups.
G. Process according to paragraph E or F, wherein the carboxylic acids mentioned and/or the alcohols mentioned have 1-20 carbon atoms.
H. Process according to any of the preceding paragraphs, wherein the at least one organic anion or anion containing an inorganic component of the first compound(s) is selected from among anions of monocarboxylic acids having from 1 to 10 carbon atoms, in particular formate, acetate and propionate, of poly-ethercarboxylic acids, in particular methoxyethoxyacetic acid (MEAH), methoxyacetic acid (MAH) or ethoxy acetic acid (EAH), of carboxylic acid ketones, in particular acetylacetones, of alcohols or alkoxy alcohols having from 1 to 20 carbon atoms, in particular with alkoxy radicals selected from among methoxy, ethoxy and propoxy, of alkane dicarboxylic acids, of (meth)acrylic acid and (meth)acrylic acid derivatives or of long-chain carboxylic acids having from 11 to 26 carbon atoms.
I. Process according to any of the preceding paragraphs, wherein each of the organic anions or anions containing an organic component which are present are made up exclusively of carbon, oxygen and hydrogen atoms.
K. Process according to any of the preceding paragraphs, wherein the at least one first compound has a plurality of different anions and/or the at least one second compound has a plurality of different anions and/or a plurality of different first and/or second compounds are provided.
L. Process according to any of the preceding paragraphs, characterized in that the compound(s) provided in step (i) have been produced by reaction of one or more salts of the corresponding cations, preferably one or more acetates, with a reactant selected from among alkane-dioic acids, long-chain carboxylic acids, ether-carboxylic acids and polyethercarboxylic acids.
M. Process according to paragraph L, wherein the reaction mentioned has been carried out in a solvent and the volatile components have been removed from the solution or suspension of the reaction product after the reaction.
N. Process according to any of the preceding paragraphs, characterized in that the protic, hydrolytically active solvent is water or a mixture of water with an organic solvent selected from among monoalcohols and dialcohols and acetone.
O. Process according to any of the preceding paragraphs, characterized in that, in step (ii), a material selected from among metal compounds which are obtained by hydrolytic condensation of elements of main groups 3 and and in particular by hydrolytic condensation of alkoxides of boron, aluminum, titanium, silicon and/or germanium and also of silanes of the formula SiR¹ₐR²_{b}X_{4-a-b} where R¹=substituted or unsubstituted C₁-C₆-alkyl, R²=substituted or unsubstituted alkenyl, X=a radical capable of hydrolytic condensation, a=0, 1 or 2 and b=0 or 1 and are present as separate particles, oxides present in powder form, alcohols, polyalcohols, carboxylic acids, micelle-forming substances, anionic or cationic surfactants and polyethylene glycols is additionally added to the solvent.
P. Process according to any of the preceding paragraphs, characterized in that the solution or suspension is brought to a temperature of 100-220° C., in particular 140-200° C., in step (iii) and/or in that a pressure of from 2 to 20 bar builds up in this step.
Q. Process according to any of the preceding paragraphs, characterized in that the solution or suspension in step (iii) contains the sum of all first compounds and, if appropriate, all second compounds in an amount corresponding to from 5 to 40% by weight, preferably from 5 to 35% by weight and more preferably from about 15 to 25% by weight, based on the corresponding oxide or oxides of the cation or cations of this/these compound(s).
R. Process according to any of the preceding paragraphs, characterized in that the solution or suspension which has been treated according to (iii) is diluted if required and then filtered through a medium having pores in the region of 1.0 μm or below.
S. Process according to any of paragraphs A to Q, characterized in that the suspension or solution formed has the form of a paste.
a. Amorphous metal-organic macromolecules comprising cations selected from among cations of manganese, cerium, gadolinium and yttrium and also organic anions and/or anions containing an organic component, where the macromolecules contain molecular or multinuclear complexes having a primary particle size of <1 nm and an agglomerate size of from 5 to 120 nm, preferably from 10 to 80 nm.
b. Amorphous metal-organic macromolecules according to paragraph a consisting of the cations and anions indicated.
c. Amorphous metal-organic macromolecules according to paragraph a comprising further cations selected from the group consisting of cations of the elements Mg, Ca, Sr, Ba, Al, Ga, In, Si, Ge, Sn, Pb, As, Sb, Te, Cu, Ag, Au, Zn, Cd, Sc, La, Pr, Nd, Pm, Sm, Eu, Er, further lanthanides, V, Nb, Ta, Cr, Mo, W, Tc, Re, Fe, Co, Ni, Ru, Rh, Pd, Os, Ir, Pt, Ti and Zr.
d. Amorphous metal-organic macromolecules according to any of paragraphs a to c, wherein the organic anions and/or anions containing an organic component are selected from among complexing and/or chelating ligands for manganese, cerium, gadolinium and yttrium cations.
e. Amorphous metal-organic macromolecules according to any of paragraphs a to c, wherein the organic anions and/or anions containing an organic component are selected from among unsubstituted or substituted anions of monocarboxylic, dicarboxylic or higher carboxylic acids, of unsubstituted or substituted monoalcohols, dialcohols or higher alcohols and of unsubstituted or substituted anions of esters, ethers and ketones.
f. Amorphous metal-organic macromolecules according to paragraph e, characterized in that the carboxylic acids mentioned and/or the alcohols mentioned each contain one or more hydroxy groups, (poly)ether groups, keto groups, amino groups or thiol groups and/or the carbon chain thereof is interrupted by oxygen and/or sulfur atoms and/or amino groups.
g. Amorphous metal-organic macromolecules according to paragraph e or paragraph f, characterized in that the carboxylic acids mentioned and/or the alcohols mentioned have from 1 to 20 carbon atoms.
h. Amorphous metal-organic macromolecules according to any of paragraphs a to g, wherein the organic anions and/or anions containing an organic component are selected from among anions of monocarboxylic acids having from 1 to 10 carbon atoms, in particular formate, acetate and propionate, of polyethercarboxylic acids, in particular methoxyethoxyacetic acid (MEAH), methoxyacetic acid (MAH) or ethoxy acetic acid (EAH), of carboxylic acid ketones, in particular acetylacetones, of alcohols or alkoxy alcohols having from 1 to 20 carbon atoms, in particular with alkoxy radicals selected from among methoxy, ethoxy and propoxy, of alkane dicarboxylic acids, of (meth)acrylic acid and (meth)acrylic acid derivatives or of long-chain carboxylic acids having from 11 to 26 carbon atoms.
j. Amorphous metal-organic macromolecules according to any of paragraphs a to h, wherein each of the organic anions or anions containing an organic component which are present are made up exclusively of carbon, oxygen and hydrogen atoms.
k. Amorphous metal-organic macromolecules according to any of paragraphs a to j comprising various cations selected from among cations of manganese, cerium, gadolinium and yttrium and/or at least two different organic anions and/or anions containing an organic component.
l. Coating material comprising amorphous metal-organic macromolecules according to any of paragraphs a to k and also a solvent or suspension medium.
m. Coating material according to paragraph 1, which further comprises a material selected from among metal compounds which are obtained by hydrolytic condensation of elements of main groups 3 and 4 and in particular by hydrolytic condensation of alkoxides of boron, aluminum, titanium, silicon and/or germanium and also of silanes of the formula SiR¹ₐR²_{b}X_{4-a-b} where R¹=substituted or unsubstituted C₁-C₆-alkyl, R²=substituted or unsubstituted alkenyl, X=a radical capable of hydrolytic condensation, a=0, 1 or 2 and b=0 or 1 and are present as separate particles, oxides present in powder form, alcohols, polyalcohols, carboxylic acids, micelle-forming substances, anionic or cationic surfactants and polyethylene glycols.
n. Use of the coating material according to paragraph 1 or m for producing oxide layers on a substrate.
o. Use according to paragraph n, wherein the oxide layers are diffusion barrier layers or epitactic layers.

What is claimed is:

1. A process for producing a material comprising amorphous metal-organic macromolecules suitable for producing ceramic oxide layers, the process comprising:
(a) providing at least one first compound of a metal cation, selected from the group consisting of the cations of manganese, cerium, gadolinium and yttrium, with at least one organic anion or anion containing an organic component;
(b) dissolving or suspending the at least one first compound in a protic, hydrolytically active solvent in such a way that the at least one first compound(s) is present in completely dissolved or colloidally dispersed form as a suspension or solution;
(c) heating the suspension or solution to at least 80° C. in a closed vessel; and
(d) depressurizing and cooling of the suspension or solution.

2. The process as claimed in claim 1, wherein at least one further first compound is provided in step (a), and wherein the cations of the at least two first compounds are identical or different.

3. The process as claimed in claim 1, further comprising, in step (a), providing at least one second compound of a metal cation selected from the group consisting of cations of the elements Mg, Ca, Sr, Ba, Al, Ga, In, Si, Ge, Sn, Pb, As, Sb, Te, Cu, Ag, Au, Zn, Cd, Sc, La, Pr, Nd, Pm, Sm, Eu, Er, further lanthanides, V, Nb, Ta, Cr, Mo, W, Tc, Re, Fe, Co, Ni, Ru, Rh, Pd, Os, Ir, Pt, Ti and Zr with at least one organic anion or anion containing an organic component, wherein the at least one second compound is provided in a mole fraction, based on the totality of the compounds present, which on incorporation into an oxide lattice of comprising the metal cation of the at least one first compound does not destroy the lattice structure of the oxide lattice.

4. The process as claimed in claim 1, wherein the at least one organic anion or anion containing an organic component of the at least one first compounds) is selected from the group consisting of complexing and chelating ligands for manganese, cerium, gadolinium and yttrium cations.

5. The process as claimed in claim 3, wherein the at least one organic anion or anion containing an organic component of the at least one first compound and/or the at least one second compound is selected from the group consisting of unsubstituted or substituted anions of monocarboxylic, dicarboxylic or higher carboxylic acids, of unsubstituted or substituted anions of monoalcohols, dialcohols or higher alcohols and unsubstituted or substituted anions of esters, ethers and ketones.

6. The process as claimed in claim 5, wherein the carboxylic acids and/or the alcohols each contain one or more hydroxy groups, (poly)ether groups, keto groups, amino groups or thiol groups and/or the carbon chain thereof is interrupted by oxygen and/or sulfur atoms and/or amino groups.

7. The process as claimed in claim 5, wherein the carboxylic acids and/or the alcohols have 1-20 carbon atoms.

8. The process as claimed in claim 1, wherein the at least one organic anion or anion containing an organic component of the at least one first compound is selected from the group consisting of anions of monocarboxylic acids having from 1 to 10 carbon atoms, in particular formate, acetate and propionate, of poly-ethercarboxylic acids, in particular methoxyethoxyacetic acid (MEAH), methoxyacetic acid (MAH) or ethoxy acetic acid (EAH), of carboxylic acid ketones, in particular acetylacetones, of alcohols or alkoxy alcohols having from 1 to 20 carbon atoms, in particular with alkoxy radicals selected from methoxy, ethoxy and propoxy, of alkane dicarboxylic acids, of (meth)acrylic acid and (meth)acrylic acid derivatives or of long-chain carboxylic acids having from 11 to 26 carbon atoms.

9. The process as claimed in claim 1, wherein each-of the organic anion or anion containing an organic component consists exclusively of carbon, oxygen and hydrogen atoms.

10. The process as claimed in claim 3, wherein the at least one first compound has a plurality of different anions and/or the at least one second compound has a plurality of different anions and/or a plurality of different first and/or second compounds are provided.

11. The process as claimed in claim 1, characterized-in-that wherein the at least one first compound provided in step (a) is produced by reacting one or more salts of the corresponding metal cations, preferably one or more acetates with a reactant selected from the group consisting of alkane-dioic acids, long-chain carboxylic acids, ether-carboxylic acids and polyethercarboxylic acids.

12. The process as claimed in claim 11, wherein the reaction is carried out in a solvent comprising volatile components in a solution or suspension, and the volatile components of the solvent are removed from the solution or suspension after the reaction.

13. The process as claimed in claim 1, wherein the protic, hydrolytically active solvent is comprises water or a mixture of water with an organic solvent selected from the group consisting of monoalcohols and dialcohols and acetone.

14. The process as claimed in claim 1, wherein in step (b), a material is added to the solvent that is selected from the group consisting of: metal compounds which are present as separate particles and obtained by hydrolytic condensation of elements of main groups 3 and 4 and in particular by hydrolytic condensation of alkoxides of boron, aluminum, titanium, silicon and/or germanium and silanes of the formula SiR^{l}ₐR²_{b}X_{4-a-b} wherein R¹=substituted or unsubstituted C₁-C₆-alkyl, R²=substituted or unsubstituted alkenyl, X=a radical capable of hydrolytic condensation, a=0, 1 or 2 and b=0 or 1, oxides present in powder form, alcohols, polyalcohols, carboxylic acids, micelle-forming substances, anionic surfactants, cationic surfactants, and polyethylene glycols.

15. The process as claimed in claim 1, wherein, in step (c), the solution or suspension is brought to a temperature of 100-220° C., in particular 140-200° C., and/or a pressure of from 2 to 20 bar builds up.

16. The process as claimed in claim 3, wherein the solution or suspension in step (c) contains the sum of all first compounds and, if appropriate, all second compounds in an amount corresponding to from 5 to 40% by weight, preferably from 5 to 35% by weight and more preferably from about 15 to 25% by weight, based on the corresponding oxide or oxides of the metal cation or cations of the first and second compound(s).

17. The process as claimed in claim 1, wherein the solution or suspension which has been treated according to step (c) is diluted if required and then filtered through a medium having pores in the range of 1.0 pm or below.

18. The process as claimed in claim 1, wherein the suspension or solution is a paste.

19. An amorphous metal-organic macromolecule comprising cations selected from the group consisting of manganese, cerium, gadolinium and yttrium cations; and organic anions and/or anions containing an organic component, wherein the macromolecules contain molecular or multinuclear complexes having a primary particle size of <1 nm and an agglomerate size of from 5 to 120 nm, preferably from 10 to 80 nm.

20. The amorphous metal-organic macromolecule as claimed in claim 19 containing exclusively said cations and said anions.

21. The amorphous metal-organic macromolecule as claimed in claim 19 further comprising cations selected from the group consisting of cations of the elements Mg, Ca, Sr, Ba, Al, Ga, In, Si, Ge, Sn, Pb, As, Sb, Te, Cu, Ag, Au, Zn, Cd, Sc, La, Pr, Nd, Pm, Sm, Eu, Er, further lanthanides, V, Nb, Ta, Cr, Mo, W, Tc, Re, Fe, Co, Ni, Ru, Rh, Pd, Os, Ir, Pt, Ti and Zr.

22. The amorphous metal-organic macromolecule as claimed in claim 19, wherein the organic anions and/or anions containing an organic component are selected from the group consisting of complexing and chelating ligands for manganese, cerium, gadolinium and yttrium cations.

23. The amorphous metal-organic macromolecule as claimed in claim 19, wherein the organic anions and/or anions containing an organic component are selected from the group consisting of unsubstituted or substituted anions of monocarboxylic, dicarboxylic acids, carboxylic acids, unsubstituted monoalcohols, substituted monoalcohols, dialcohols, higher alcohols, unsubstituted anions of esters, ethers and ketones, and substituted anions of esters, ethers and ketones.

24. The amorphous metal-organic macromolecule as claimed in claim 23, wherein the carboxylic acids and/or the alcohols each contain one or more hydroxy groups, (poly)ether groups, keto groups, amino groups or thiol groups and/or the carbon chain thereof is interrupted by oxygen and/or sulfur atoms and/or amino groups.

25. The amorphous metal-organic macromolecule as claimed in claim 23 wherein the carboxylic acids mentioned and/or the alcohols have from 1 to 20 carbon atoms.

26. The amorphous metal-organic macromolecule as claimed in claim 19, wherein the organic anions and/or anions containing an organic component are selected from the group consisting of anions of monocarboxylic acids having from 1 to 10 carbon atoms, in particular formate, acetate and propionate, of polyethercarboxylic acids, in particular methoxyethoxyacetic acid (MEAH), methoxyacetic acid (MAH) and ethoxy acetic acid (EAH), of carboxylic acid ketones, in particular acetyl acetones, of alcohols and alkoxy alcohols having from 1 to 20 carbon atoms, in particular with alkoxy radicals selected from among methoxy, ethoxy and propoxy, of alkane dicarboxylic acids, of (meth)acrylic acid and (meth)acrylic acid derivatives and of long-chain carboxylic acids having from 11 to 26 carbon atoms.

27. The amorphous metal-organic macromolecule as claimed in claim 19, wherein each of the organic anions or anions containing an organic component consist exclusively of carbon, oxygen and hydrogen atoms.

28. The amorphous metal-organic macromolecule as claimed in claim 19, comprising cations selected from cations of the group consisting of manganese, cerium, gadolinium and yttrium and/or comprising at least two different organic anions and/or anions containing an organic component.

29. A coating material comprising amorphous metal-organic macromolecules as claimed in claim 19 and further comprising a solvent or suspension medium.

30. The coating material as claimed in claim 29, further comprising a material selected from the group consisting of metal compounds which are present as separate particles and obtained by hydrolytic condensation of elements of main groups 3 and 4 and in particular by hydrolytic condensation of alkoxides of boron, aluminum, titanium, silicon and/or germanium and silanes of the formula SiR¹ₐR²_{b}X_{4-a-b} wherein R¹=substituted or unsubstituted C₁-C₆-alkyl, R²=substituted or unsubstituted alkenyl, X=a radical capable of hydrolytic condensation, a=0, 1 or 2 and b=0 or 1, oxides present in powder form, alcohols, polyalcohols, carboxylic acids, micelle-forming substances, anionic surfactants, cationic surfactants, and polyethylene glycols.

31. A method for producing an oxide layer on a substrate, the method comprising:
applying the coating material of claim 29 to the substrate; and
drying, heating, and/or sintering the coated substrate whereby the oxide layer is formed.

32. The method of claim 31, wherein the oxide layer is a diffusion barrier layer or an epitactic layer.
